(19) United States
(12) Patent Application Publication
(10) Pub. No.: US 2025/0284622 A1
(43) Pub. Date: Sep. 11, 2025

(54) COMPUTER-IMPLEMENTED METHOD AND CORRESPONDING SYSTEM FOR PORTING SOFTWARE ARTEFACTS FROM A SOURCE SYSTEM TO ANOTHER TARGET SYSTEM BASED ON A PORTING STRATEGY

(71) Applicant: Siemens Aktiengesellschaft, Munchen (DE)

(72) Inventors: Christian Körner, Bergen (DE); Lars Gelbke, Mansfeld (DE)

(21) Appl. No.: 18/601,685

(22) Filed: Mar. 11, 2024

(51) Int. Cl. G06F 11/36

(52) U.S. Cl. CPC G06F 11/3692

(57) ABSTRACT

A computer-implemented method including quantifying pre-defined technical porting goal of a porting project into a technical value model, receiving selected decisions regarding the target system and porting tasks and current version of the porting system, executing traceable porting steps based on the selected decisions, porting tasks and current version of the porting system and creating software artefacts of the target system, evaluating software artefacts created or converted by each of the executed porting steps and/or evaluating test results by applying and/or simulating each ported software artifact, outputting references to the versions of created and/or converted and evaluated software artifacts into a porting log, and training the creation and evaluation component of the porting system with data of the porting log based on the decisions and the outcome of the porting project using porting mechanism to reach the pre-defined goal for the porting system.

### BACKGROUND

The present invention relates to a computer-implemented method and corresponding porting software artifacts from a source system to another target system based on a porting strategy.

Industry uses outdated (legacy) software systems to keep daily processes running. Porting of the systems to newer (up to date) software platforms is mostly postponed until a time point where reimplementing or replacement can be made.

Legacy software poses a substantial security risk, locks processes/procedures into old inefficient workflows and hinders the evolution to a point where process are inefficient and unprofitable. Porting would set the stage for improvements and reap benefit of technical progress of new hard- and software platforms.

However, porting is seen a kind of losing game by the stakeholders who must undertake it. Technical experts waste their lifetime on old technology and other people's deficiencies trying to recover the “why” (mostly undocumented) and the “what” behind a cryptic procedural “how” in a tedious mostly manual error prone process. As there is a good chance of getting stuck in a dying process on outdated technology these porting projects are even less attractive.

It's crucial to evaluate the specific requirements and constraints of each migration project to choose the most appropriate tools and methods. Additionally, staying informed about the latest advancements in cloud technologies and migration tools is essential for successful legacy migration projects.

Automated code migration tools and services are designed to assist in the process of migrating code from one environment to another, often with the goal of updating or modernizing the codebase. Application of AI in code migration is possible and a rapidly evolving field. The effectiveness of these AI-based tools may vary based on the specific requirements of the migration project, the programming languages involved, and the complexity of the legacy codebase.

Porting does not only mean code adaption/generation. In addition to adapting existing software code/creating new software code and moving it to another platform, all software artifacts need to be analyzed and adapted.

A software artifact is a by-product of software development that helps to describe the architecture, design, and function of software. Artifacts are like roadmaps that software developers can use to trace the entire software development process. Technically, artifacts can be databases, data models, printed documents or scripts. Artifacts aid in the maintenance and updating of software, as developers can use them as reference material to help resolve issues. Artifacts should be documented and stored in a repository so they can be retrieved by software developers upon demand.

In view of this, the objective is to develop an efficient and reliable porting support with as many automated porting steps as possible.

### SUMMARY

The above-mentioned objective is achieved by a method and one or more apparatus and/or a system and/or a device according to the features of the independent claims.

Preferred embodiments of the invention are described in the dependent claims. Any combination of the features of the dependent claims to each other and with the features of the independent claims is possible.

An aspect of the invention is a computer-implemented method for porting software artefacts from a source system or platform to another target system or platform based on a porting strategy, wherein the following method steps are performed by components of a porting system which are hardware components and/or software components executed by one or more processors:
a) Quantifying pre-defined technical porting goal of a porting project into a technical value model;
b) Receiving, by an UI (user interface) connector, selected decisions regarding the target system and porting tasks and current version of the porting system;
c) Executing, by a porting component, traceable porting steps based on the selected decisions, porting tasks and current version of the porting system and creating software artefacts of the target system;
d) Evaluating, by a evaluation component, software artifacts created or converted by each of the executed porting steps and/or evaluating test results by applying and/or simulating each ported software artefact based on a given quality model of the porting project and on the technical value model;
e) Outputting, by an output component, references to the versions of created and/or converted and evaluated software artifacts including the evaluation results into a porting log and presenting to a user interface device;
f) Training, by a training component, the creation and evaluation component of the porting system with data of the porting log based on the decisions and the outcome of the porting project using porting mechanism to reach the pre-defined goal for the porting system.

Decisions (see b)) can be selected from a user interface device or bot in more advanced versions.

Porting goals comprise—on a very high system engineering level—of the provision of functionality and use cases to the users of the legacy system by means of the ported system replacing the legacy system. System quality often needs to be extended to cope with a new socio-economical situation e.g. sustainability and information security. This distinction of functionality and quality is a mean to improve usability for system users and to reduce the mental load of the system designers and is valid on one level only. On another level it is made again but with different content. Quality is implemented by functionality. Functionality requires different qualities on the other level.

In order to make these concepts of functionality and nonfunctional quality technically tractable (controllable) it is mapped to a numerical metric system called a technical value model. The value model is a technical surrogate to measure the completion of system level functionality and quality. Especially qualities on system level are hard (meaning impossible with available efforts) to measure directly. Therefore a quality model is used based on indicators applied to more detailed levels of the system. Both provide in an automated way insight in the scope and progress of the porting project. Supporting artefacts of a software systems like requirements, architectural design documents, support and training documents, test, deployment and monitoring are often rated with respect to the process maturity they support. This idea of maturity is used to set the scope of document quality of support artefacts. As standards for support documentation are different within the respective organisations and changing for instance regarding software development strategies or improvement programs they need to be trained to the porting system.

Therefore the porting and evaluation component can switch into different kinds of training modus (for step f)) whereby each training modus determines which kind of AI-based and/or rule-based trainable model supports the creation and evaluation component.

As each porting step is traceable because it is logged and validated together with decisions they are based on.

If evaluation results miss the pre-defined porting goal, the selected decision can be retrieved and/or reselected and/or evaluated software artifacts are recreated and/or reconverted and/or the porting goal and training goal can be redefined.

Evaluation results can be presented as distance between a porting goal and the outcome of the porting project on the user interface device. So the user can recognize the outcome of the porting steps and correct his/her decisions.

If evaluation results meet the pre-defined porting goal, the porting goal and training goal can be raised.

Porting step successfully evaluated can be trained to a GenAI (Generative Artificial Intelligent model) or LLM (Large Language model) systems or added as rules to the rule-based systems. A knowledgebase can be extended or cleaned up accordingly.

The porting system can be designed as a self-improving system. After the training and learning as described in f) the porting and evaluation component are improved. So the porting system changes from a former version to a subsequent version. Versions are needed to roll back from a younger version to an older version if the evaluation results remain insufficient or errors occur.

After the training steps b) to e) can be repeated and followed by step f) as long as the porting goal has not been reached or a pre-defined event has been occurred or a pre-defined time period has been lapsed.

Training can incorporate an artifact-based maturity rating of each source and/or target system artifact to generate a higher quality of the software artifacts and test results.

Patent application US 2024/0020118 A1 discloses a system for measurement and control of KPI (Key performance indicator) for value engineering in software intensive systems. There is a recommender system for analyzing the current evolution/maturity degree depending on the assigned values, for estimating a quality and/or performance trend derived from the evolution degree and from the aggregated data from the at least one history data source. Focus—here—is on actionable measures (so called KPIs) which are used to reach appropriate maturity level of the system. It can start simple at low maturity level and improve during the project incrementally. Maturity models are known like Capability Maturity Model Integration (CMMI; https://en.wikipedia.org/wiki/Capability_Maturity_Model_Integration).

The gain by a well ported and modernized software system is made visible. The volume of tedious work with old technology is automated and remaining manual work and decisions are appreciated and rewarded through the evaluation step.

By facilitating porting with GenAI and rule-based and formal language technologies supports the technical work of technical experts on modern and fast evolving technologies. These technologies are data-driven, meaning they accumulate porting and domain knowledge in form of data, which can improve porting incrementally and maybe can be shared with other organizations, teams, and technologies.

The quality model maintenance can be based on GenAI tech. Porting quality models to new code scanner versions and after each port the GenAI model is improved with the knowledge of the ported Quality Model containing new rule and pattern.

The technical problems being addressed are:
1. Designing a software transformation system into a closed loop from porting stories to software system evaluation.
2. Separation of portable software part from those that should not be ported.
3. Separation of manual porting steps from automated steps.
4. Capture of knowledge added by the porting expert from the UI side.
5. Trackability and accountability of the automated porting system.
6. Extensibility and Scalability

A further aspect of the invention is a system for porting software functions from a source system or platform to another target system or platform, comprising:
a) a quantification component configured for quantifying pre-defined technical porting goal of a porting project into a technical value model;
b) an user interface connector configured for receiving selected decisions regarding the target system and porting tasks and current version of the porting system;
c) a porting component configured for executing traceable porting steps based on the selected decisions, porting tasks and current version of the porting system and configured for creating software artefacts of the target system;
d) an evaluation component configured for evaluating software artifacts created or converted by each of the executed porting steps and/or evaluating test results by applying and/or simulating each ported software artifact based on a given quality model of the porting project and on the technical value model;
e) an output component configured for outputting references to the versions of created and/or converted and evaluated software artefacts including the evaluation results into a porting log and presenting to a user interface device;
f) a training component configured for training the creation and evaluation component of the porting system with data of the porting log based on the decisions and the outcome of the porting project using porting mechanism to reach the pre-defined goal for the porting system.

The processor can steer and/or control and/or load and/or execute method steps of the above mentioned method. The processor can be part of a server or of a runtime environment within the multi-user system.

Embodiments as described above for the method can be analogous applied for the system and for computer program (product) and for the computer-readable storage and/provisioning medium.

Systems can be implemented by hardware, firmware and/or software modules or a combination of them.

The computer-readable storage medium stores instructions executable by one or more processors of a computer, wherein execution of the instructions causes the computer system to perform the method. The one or more processors can be distributed organized on servers or in a cloud.

The computer program (product) is executed by one or more processors of a computer and performs the method.

### BRIEF DESCRIPTION

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. In the figures, identical or functionally identical elements are denoted by identical reference signs. Included in the drawings are the following figures:

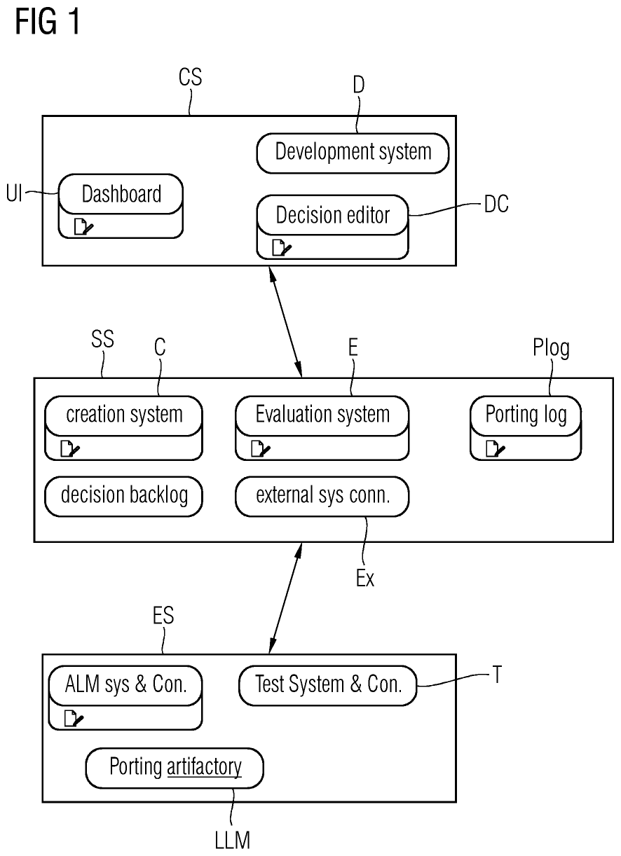

FIG. 1 shows modules of inventive system and its environment, and

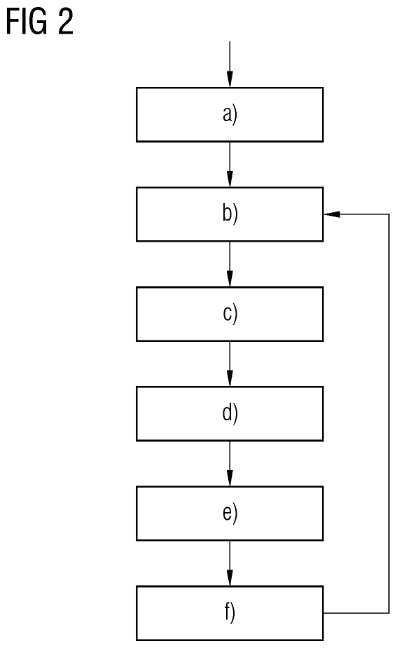

FIG. 2 shows a flow chart of the inventive method.

### DETAILED DESCRIPTION

As shown in the FIG. 1 the system comprises the following components und/or modules respectively.

The system uses client components for information processing and server components for software artifact creation. External test and ALM systems (application lifecycle management) are connected via connectors.
1. Client CS components:
   1.1 A user interface UI designed as a dashboard
   1.2 A development component
   1.3 A decisions editor DC
2. Server SS components:
   2.1 A porting/creation component C
      2.1.1 Application programming interfaces (API)
      2.1.2 Code
      2.1.3 Test
      2.1.4 Documentation
   2.2 A evaluation component E
   2.3 A porting log P log
   2.4 A decision backlog
   2.5 A external system connector
3. A connected external system ES
   3.1 AML System and Connector
   3.2 Test System TT and Connector
   3.3 A porting artifactory LLM

### Ad 1. Client

### Ad. 1.2 Development Component:

In a development component/system like e.g. Microsoft's Studio Code for porting legacy applications, the viewing, browsing, and search capabilities extend beyond the user interface and encompass various aspects of the application, including documentation, code, tests, and data.

Documentation: The development system provides tools to easily view and browse documentation associated with the legacy application. It may include features like a built-in documentation viewer, search functionality within the documentation, and the ability to navigate through different sections or topics efficiently.

Code Viewing and Browsing: The development system offers code browsing and viewing capabilities, allowing developers to navigate through the codebase of the legacy application. This includes features like code highlighting, code folding, and the ability to jump to definitions or references. It enables developers to understand and analyze the existing code structure more effectively.

Test Exploration: The development system allows developers to explore and analyze the existing tests associated with the legacy application. It provides features for viewing test cases, test results, and test coverage reports. Developers can easily navigate through the test suite, search for specific tests, and examine the test code to understand the test coverage and identify areas for improvement.

Data Exploration: The development system facilitates browsing and exploration of data within the legacy application. It may include tools for querying databases, visualizing data relationships, and filtering data based on specific criteria. This enables developers to gain insights into the data structure and make informed decisions during the migration process.

Search Capabilities: The development system offers advanced search functionalities across different aspects of the application, including documentation, code, tests, and data. Developers can search for specific keywords, classes, methods, variables, or even data values. This helps locate relevant information quickly and efficiently, making the migration process more streamlined.

Overall, a development system like Microsoft's Studio Code focuses on providing comprehensive viewing, browsing, and search capabilities across documentation, code, tests, and data to assist in the porting of legacy applications. These features enhance developers' productivity, improve code understanding, and facilitate efficient exploration of different aspects of the application.

### Ad 1. 1 Dashboard:

A dashboard for an automated porting system serves as a central interface for visualizing and controlling the porting process. It provides insights and control for porting rounds. The dashboard typically includes the following components:

Visualization: The dashboard displays the maximum value that can be achieved in the porting round. It also shows the current achieved value, representing the resources or rewards earned during the porting round. This visualization helps monitor progress and rewards successful porting rounds.

Resource credits: This section visualizes the amount of resource credits available for each porting round. Resource credits represent resources allocated for the porting process. The visualization may show the current balance of resource credits and any changes over time, providing a clear view of available resources.

Debts: The dashboard presents different types of debts associated with the porting process within a porting round of a porting project. This includes functional debt, quality debt, infrastructure debt, and decision-related debt. Visualizing these debts helps to identify areas that may require attention or improvement during the porting round.

Control: The dashboard allows users to select the decision they want to make for a specific porting round. This could involve choosing the specific legacy application to port, selecting the target platform, or deciding on the porting strategy. Users can make informed decisions based on the available information and insights provided on the dashboard.

The dashboard provides a control mechanism to initiate/start a porting round. Users can trigger the start of a porting round, which will utilize the allocated resource credits and begin the automated porting process.

Acceptance or rejection of porting round Results: Once a porting round is completed, the dashboard allows users to review the results. Users can accept or reject the outcome based on their assessment of the porting process. This decision may impact the resource credits, debt, and overall progress of the porting round.

The dashboard enables users to allocate resource credits for each porting round. Users can set goals for the specific round based on factors like complexity, urgency, or strategic importance. This helps in managing the available resources effectively and optimizing the porting process.

Overall, the dashboard for an automated porting system provides visualization of key metrics such as the maximum value for an achieved goal, resource credits, and various types of debt. It also offers control over decision-making, porting round initiation, and acceptance or rejection of results. Additionally, users can budget resource credits for each porting round, ensuring efficient allocation of resources throughout the porting process.

### Ad 1.3 Decision Editor:

A decision editor works alongside the dashboard to guide the porting process and provide traceability of the porting steps. This editor allows users to create decisions that dictate the behavior and actions of the automated porting system. The decisions cover various aspects of software engineering and ensure that the ported system meets the desired goals. Some examples of decisions include:
Module selection: The decision editor allows users to specify which modules of the legacy software artifacts should be ported, omitted, or replaced. This helps to define the scope and boundaries of the porting process.
Functionality Specification: Users can define the functionality that should be supported by the ported system. This includes identifying key features, use cases, and requirements that need to be preserved or enhanced during the porting process.
Hazardous code removal and recreation: The decision editor enables users to identify and remove hazardous or obsolete code from the legacy software. They can also specify the recreation of certain code segments to ensure the ported system is secure and up to date.
Test Coverage and Test Types: Users can define the desired test coverage and specify the types of tests that should be conducted during the porting process. This ensures that the ported system is thoroughly tested for functionality, performance, and reliability.
Quality Goals: The decision editor allows users to set quality goals for the ported system. This may include specifying performance targets, code maintainability standards, security requirements, and other quality attributes that the automated porting system should achieve. In some cases, decisions may already be preset by enterprise architecture and coding playbooks. However, for legacy software artifacts, where such concepts may be outdated or non-existent, the decision editor becomes crucial. It enables users to provide up-to-date information to the automated porting system in the form of decisions, ensuring that the porting process aligns with the desired goals.

Overall, the decision editor module of an automated porting system guides the porting process by allowing users to create decisions that cover various aspects of software engineering. It ensures that the ported system meets the desired functionality, quality, and architectural goals.

### Ad 2 Server:

### Ad 2.1 Porting/Creation Component

A creation component for an automated porting system is responsible for generating or converting software artifacts for both the source and target platforms. In the context of porting, the creation system is focused to API (Application Programming Interface), code, tests, and documentation.

The creation system focuses on generating or converting software artifacts to ensure compatibility between the legacy system and the target platform. This involves mapping and adapting the existing APIs to fit the requirements of the target platform, enabling seamless integration and interaction between different components.

Code generation is another crucial aspect of the creation component. It involves creating code for the old platform that serves as a comparable reference for the porting process. This reference code helps in ensuring a stepwise transition of data and functionality from the legacy system to the target platform. By having code that mirrors the functionality of the legacy system, the creation component provides a solid foundation for the subsequent steps in the porting process.

The creation component also handles the generation or conversion of tests to ensure proper test coverage for the ported system. This includes adapting existing tests or creating new ones to validate the functionality and performance of the ported code.

Additionally, the creation component is responsible for converting or adapting the existing documentation to be compatible with the target platform. This ensures that the necessary information and instructions are available for developers and users of the ported system. The creation component for an automated porting system provides an economically viable intermediate solution between the legacy system and a completely redesigned system. While the porting system lays the foundation for the forward engineering system, which addresses user experience (UX) architecture and requirements, the creation component focuses on generating or converting APIs, code, tests, and documentation to facilitate a smooth and controlled transition from the legacy system to the target platform. So after receiving, by an UI connector, the selected decisions regarding the target system and porting tasks and current version of the porting system from the user interface UI according to reference sign b) in FIG. 2, the creation/porting component performs the mentioned porting steps based on the selected decisions, porting tasks and current version of the porting system (see reference sign c) in FIG. 2.

### Ad 2.2 Evaluation Component:

An evaluation component for an automated porting system is responsible for assessing the quality of software artifacts and test results using rule-based search, formal languages, and statistical data. The evaluation component retrieves this information, which is then used by the dashboard to create and visualize high-level Key Performance Indicators (KPIs).

The evaluation component rule-based search and formal languages to analyze the software artifacts and test results. It applies predefined rules and criteria to assess the quality of the artifacts, such as code readability, maintainability, adherence to coding standards, and compliance with industry best practices. Formal languages may be used to verify the correctness and completeness of the code.

In addition to rule-based analysis, the evaluation component also can utilize statistical data to evaluate the quality of the software artifacts and test results. Porting goal needs to be quantified (siehe reference sign a)). This can involve analyzing metrics such as code complexity, test coverage, and defect density to provide quantitative insights into the quality of the ported system. Usually measure and thresholds define a technical value model.

The dashboard retrieves the information generated by the evaluation component to create and visualize high-level KPIs. These KPIs provide an overview of the quality of the ported system and help stakeholders monitor the progress and effectiveness of the porting process.

Both the porting log and the creation component access the quality information provided by the evaluation component. The creation component uses this information to fine-tune its operations and to improve the quality of the generated or converted software artifacts. The porting log, on the other hand, stores the KPIs, configuration information, and operational data after each porting round. This allows historical tracking and analyzing the porting process.

Overall, the evaluation component assesses/evaluates the quality and technical value of software artifacts created or converted by each of the executed porting steps and evaluates test results by applying and/or simulating each ported software artifact (see reference sign d) in FIG. 2).

It utilizes rule-based search, formal languages, and statistical data to provide objective insights into the quality of the ported system. The information generated by the evaluation component, which is output to the user interface (see reference sign e) in FIG. 3), is then utilized by the dashboard, porting log, and creation component to monitor progress, make improvements, and ensure the overall quality of the porting process.

### Ad 2.3. Porting Log:

Porting log collects metadata for the porting rounds, the setup information, and the final appraisal.

The porting log stores the KPIs, configuration information, and operational data after each porting round. This allows historical tracking and analyzing the porting process.

### Ad 2.4 Decision Backlog:

Decision backlog is a distributed storage and control for the decision editor.

### Ad 2.5 External System Connector:

Connectors for external systems which store and handle the mass data for legacy and ported system.

### Ad 3 External Systems:

### Ad 3.1 ALM System:

Responsibility of the AML System is to provide version and configuration management for the legacy and the ported system.

### Ad 3.2 Test System:

Legacy and ported system are tested automatically by the test system.

### Ad 3.3. Porting Artefactory LLM

Porting Artifactory holds the porting knowledge base comprising rules, learning patterns and versions of the porting system as well as which kind of large language/AI model is used to improve the porting system. This knowledge can be used in the training by a not shown training component (see reference sign f) in FIG. 2). The porting system can be designed as a self-improving system. After the training and learning the porting and evaluation component are improved. So the porting system changes from a former version to a subsequent version.

As shown in FIG. 2 steps b) to e) can be repeated and followed by step f) as long as the porting goal has not been reach or an pre-defined event has been occurred or a pre-defined time period has been lapsed.

The system can be use technically for different porting scenarios:
1. Porting from the source to the target system.
2. Training of experts and improving of porting system
   training roles (porting system owner and porting experts)
   competitive porting: optimizing porting resources (time, computing expenses, cycles) to value created
   Tuning porting systems to improve porting quality of target system
3. technical strategy to focus on different quality of target systems:
   3.1 Capture porting knowledge to improve porting
      automation grade
      quality of resulting system
   3.2 tuning the porting system to improve underlying evaluation system
      effort per cycle to real effort per cycle
      estimated systems quality to real system quality (in testing or execution)
      estimated system value to perceived use and value in test deployments.
   3.3 Tuning the porting system towards strategic KPIs like Software maturity:
      Artifacts created in SW engineering reflect the maturity level for an organization. For Artifact created by automatic porting the same requirements hold some the porting system can be tuned to reach predefined (software engineering strategy).

The invention has been described in detail with reference to embodiments thereof and examples. Variations and modifications are possible. Instead of the above-described production process one or more processes can analogously be applied to other technical systems.

The multi user system and its parts can be (computer-) implemented for performing the inventive method steps.

Parts of the system can be integrated into a (computer) cloud system. It includes one or more processors and can be coupled with data, where said processor(s) is/are configured to execute the method steps.

The method can be executed by at least one processor such as a microcontroller or a microprocessor, by an Application Specific Integrated Circuit (ASIC), by any kind of computer, including mobile computing devices such as tablet computers, smartphones or laptops, or by one or more servers in a control room or cloud.

For example, a processor, controller, or integrated circuit of the systems and/or computer and/or another processor may be configured to implement the acts described herein.

The above-described method may be implemented via a computer program (product) including one or more computer-readable storage media having stored thereon instructions executable by one or more processors of a computing system and/or computing engine. Execution of the instructions causes the computing system to perform operations corresponding with the acts of the method described above.

The instructions for implementing processes or methods described herein may be provided on non-transitory computer-readable storage media or memories, such as a cache, buffer, RAM, FLASH, removable media, hard drive, or other computer readable storage media. A processor performs or executes the instructions to train and/or apply a trained model for controlling a system. Computer readable storage media include various types of volatile and non-volatile storage media. The functions, acts, or tasks illustrated in the figures or described herein may be executed in response to one or more sets of instructions stored in or on computer readable storage media. The functions, acts or tasks may be independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

In addition, and alternatively, it is possible that a control device receives other computer-readable control signals in order to initiate the mentioned steering/control process by its processor(s).

The invention has been described in detail with reference to embodiments thereof and examples. Variations and modifications may, however, be effected within the spirit and scope of the invention covered by the claims. The phrase “at least one of A, B and C” as an alternative expression may provide that one or more of A, B and C may be used.

The terminology used herein is for the purpose of describing particular embodiments only and is not intended to be limiting of example embodiments of the invention. As used herein, the singular forms “a”, “an”, and “the” are intended to include the plural form as well, unless the context clearly indicates otherwise.

It is to be understood that the elements and features recited in the appended claims may be combined in different ways to produce new claims that likewise fall within the scope of the present invention. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

None of the elements recited in the claims are intended to be a means-plus-function element unless an element is expressly recited using the phrase “means for” or, in the case of a method claim, using the phrases “operation for” or “step for”.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for porting software artefacts from a source system to another target system based on a porting strategy, wherein the following method steps are performed by components of a porting system which are hardware components and/or software components executed by one or more processors:
a) Quantifying pre-defined technical porting goal of a porting project into a technical value model;
b) Receiving, by an UI connector, selected decisions regarding the target system and porting tasks and current version of the porting system;
c) Executing, by a porting component, traceable porting steps based on the selected decisions, porting tasks and current version of the porting system and creating software artefacts of the target system;
d) Evaluating, by a evaluation component, software artefacts created or converted by each of the executed porting steps and/or evaluating test results by applying and/or simulating each ported software artifact based on a given quality model of the porting project and on the technical value model;
e) Outputting, by an output component, references to the versions of created and/or converted and evaluated software artifacts including the evaluation results into a porting log and presenting to a user interface device;
f) Training, by a training component, the creation and evaluation component of the porting system with data of the porting log based on the decisions and the outcome of the porting project using porting mechanism to reach the pre-defined goal for the porting system.

2. The method according to claim 1, wherein the creation and evaluation component can switch into different kinds of training modus whereby each training modus determines which kind of AI-based and/or rule-based trainable model supports the porting and evaluation component.

3. The method according to claim 1, wherein training incorporates an artifact-based maturity rating of each source and/or target system artifact to generate a higher quality of the software artifacts and test results.

4. The method according to claim 1, wherein if evaluation results miss the pre-defined porting goal, the selected decision are retrieved and/or reselected and/or evaluated software artifacts are recreated and/or reconverted and/or the porting goal and training goal are redefined.

5. The method according to claim 1, wherein if evaluation results meet the pre-defined porting goal, the porting goal and training goal are raised.

6. The method according to claim 1, wherein evaluation results are presented as distance between a porting goal and the outcome of the porting project on the user interface device.

7. A system for porting software functions from a source system to another target system, comprising:
a) a quantification component configured for quantifying pre-defined technical porting goal of a porting project into a technical value model;
b) an user interface connector configured for receiving selected decisions regarding the target system and porting tasks and current version of the porting system;
c) a porting component configured for executing traceable porting steps based on the selected decisions, porting tasks and current version of the porting system and configured for creating software artefacts of the target system;
d) an evaluation component configured for evaluating software artifacts created or converted by each of the executed porting steps and/or evaluating test results by applying and/or simulating each ported software artefact based on a given quality model of the porting project and on the technical value model;
e) an output component configured for outputting references to the versions of created and/or converted and evaluated software artifacts including the evaluation results into a porting log and presenting to a user interface device;
f) a training component configured for training the creation and evaluation component of the porting system with data of the porting log based on the decisions and the outcome of the porting project using porting mechanism to reach the pre-defined goal for the porting system.

8. A computer program comprising instructions which, when the program is executed by a computer, cause the computer to carry out a method according to claim 1.

9. A storage and/or provisioning device for the computer program according claim 8, wherein the storage and/or provisioning device stores and/or provides the computer program.
